(19) United States
(12) Patent Application Publication
(10) Pub. No.: US 2025/0100362 A1
(43) Pub. Date: Mar. 27, 2025

(54) VEHICLE SEALING ASSEMBLY

(71) Applicant: GM Global Technology Operations LLC, Detroit, MI (US)

(72) Inventors: Larry A. Filipczak, West Bloomfield, MI (US); Roland A. Payne, Riley Center, MI (US)

(21) Appl. No.: 18/471,363

(22) Filed: Sep. 21, 2023

(51) Int. Cl. B60J 10/84; B60J 10/246; B60J 10/70; B62D 25/04

(52) U.S. Cl. CPC B60J 10/84; B60J 10/70; B62D 25/04; B60J 10/246

(57) ABSTRACT

A scaling assembly includes a first structure having a first flange, a second structure having a second flange that partially overlaps the first flange, a fastener that attaches the first flange to the second flange at a region where the first flange and the second flange overlap, and a seal disposed over the first flange and the second flange.

### INTRODUCTION

The subject disclosure relates to the art of vehicle sealing.

Water ingress into vehicles can pose significant challenges. Therefore, a seal that prevents water from entering the vehicle is desirable.

### SUMMARY

In one exemplary embodiment, a sealing assembly comprises a first structure having a first flange, a second structure having a second flange that partially overlaps the first flange, a fastener that attaches the first flange to the second flange at a region where the first flange and the second flange overlap, and a seal disposed over the first flange and the second flange.

In addition to one or more of the features described herein, the first structure comprises a tapered portion at the region where the first flange and the second flange overlap and the seal is disposed over the tapered portion.

In addition to one or more of the features described herein, the sealing assembly further comprises a sealing patch disposed between the first flange and the second flange at the region where the first flange and the second flange overlap, and the fastener brings the first flange and the second flange together to compress the sealing patch.

In addition to one or more of the features described herein, the seal is disposed over the fastener.

In another exemplary embodiment, a vehicle sealing assembly comprises a division post having a division post flange, a door frame having a door frame flange, a first fastener that attaches the division post flange to the door frame flange at a region where the division post flange and the door frame flange overlap, and a seal disposed over the division post flange and the door frame flange.

In addition to one or more of the features described herein, the division post comprises a first tapered portion at the region where the division post flange and the door frame flange overlap and the seal is disposed over the first tapered portion.

In addition to one or more of the features described herein, the vehicle sealing assembly further comprises a first sealing patch disposed between the division post flange and the door frame flange at the region where the division post flange and the door frame flange overlap, and the first fastener brings the division post flange and the door frame flange together to compress the first sealing patch.

In addition to one or more of the features described herein, the seal is disposed over the first fastener.

In addition to one or more of the features described herein, the vehicle sealing assembly further comprises a quarter panel having a quarter panel flange, and a second fastener that attaches the division post flange to the quarter panel flange at a region where the division post flange and the quarter panel flange overlap, and the seal is disposed over the quarter panel flange.

In addition to one or more of the features described herein, the division post comprises a second tapered portion at the region where the division post flange and the quarter panel flange overlap and the seal is disposed over the second tapered portion.

In addition to one or more of the features described herein, the vehicle sealing assembly further comprises a second sealing patch disposed between the division post flange and the quarter panel flange at the region where the division post flange and the door frame flange overlap, and the second fastener brings the division post flange and the quarter panel flange together to compress the second sealing patch.

In addition to one or more of the features described herein, the seal is disposed over the second fastener.

In addition to one or more of the features described herein, the door frame flange, the division post flange, and the quarter panel flange together form a continuous perimeter of an opening.

In addition to one or more of the features described herein, the seal is disposed continuously on the continuous perimeter of the opening.

In addition to one or more of the features described herein, the first tapered portion extends from the division post in a forward direction of a vehicle on which the vehicle sealing assembly is configured to be disposed.

In addition to one or more of the features described herein, the second tapered portion extends from the division post in a downward direction of a vehicle on which the vehicle sealing assembly is configured to be disposed.

In addition to one or more of the features described herein, the division post is formed as a unitary structure with a quarter window backer.

In yet another exemplary embodiment, a vehicle comprises a vehicle body, a rear door frame having a rear door frame flange, a quarter panel having a quarter panel flange, a division post extending between the rear door frame and the quarter panel and having a division post flange, a rear door assembly including a rear door and a rear window disposed over at least a portion of each of the rear door frame, the quarter panel, and the division post, a first fastener that attaches the division post flange to the rear door frame flange at a region where the division post flange and the rear door frame flange overlap, a second fastener that attaches the division post flange to the quarter panel flange at a region where the division post flange and the quarter panel flange overlap, and a seal disposed over the division post flange, the rear door frame flange, and the quarter panel flange.

In addition to one or more of the features described herein, the division post comprises a first tapered portion at the region where the division post flange and the rear door frame flange overlap, the division post comprises a second tapered portion at the region where the division post flange and the quarter panel flange overlap, and the seal is disposed over the first tapered portion and the second tapered portion.

In addition to one or more of the features described herein, the vehicle further comprises a first sealing patch disposed between the division post flange and the rear door frame flange at the region where the division post flange and the rear door frame flange overlap, and a second sealing patch disposed between the division post flange and the quarter panel flange at the region where the division post flange and the rear door frame flange overlap, the first fastener brings the division post flange and the rear door frame flange together to compress the first sealing patch, and the second fastener brings the division post flange and the quarter panel flange tougher to compress the second sealing patch.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a rear door assembly according to a non-limiting example;

FIG. 2 shows a rear door assembly with the door removed according to a non-limiting example;

FIG. 3 shows a cross-sectional view taken at 3-3 in FIG. 2 of a rear door seal disposed on a division post according to a non-limiting example;

FIG. 4. shows a division post attached to a rear door frame and a quarter window frame according to a non-limiting example;

FIG. 5 shows a division post attached to a quarter panel according to a non-limiting example;

FIG. 6 shows a division post attached to a rear door frame and a quarter panel frame according to a non-limiting example;

FIG. 7 is a cross-sectional view taken at 7-7 in FIG. 6 showing a division post attached to a rear door frame when according to a non-limiting example; and

FIG. 8 is a cross-sectional view taken at 8-8 in FIG. 6 showing a division post attached to a rear door frame and a quarter panel frame according to a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

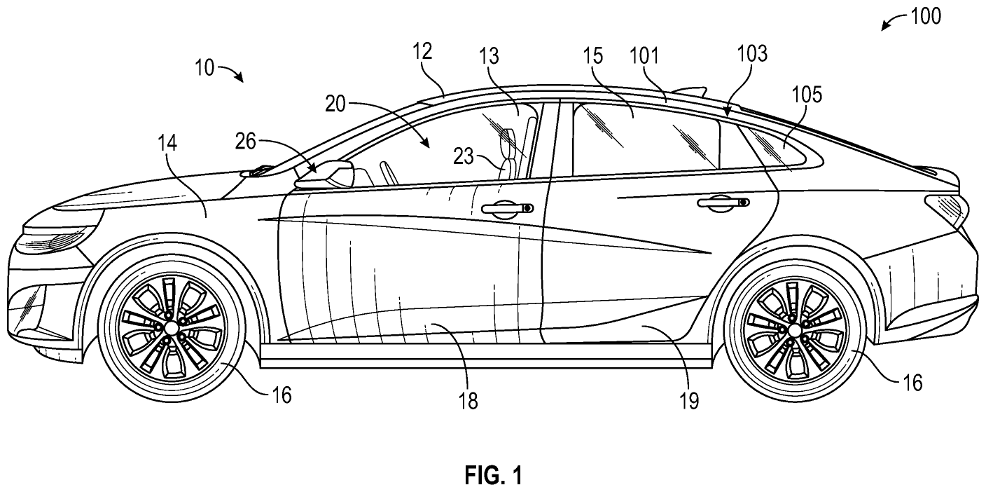

FIG. 1 shows a vehicle 10 according to a non-limiting example. The vehicle 10 includes a vehicle body 12 supported on a plurality of wheels 16. One or more of the plurality of wheels 16 is steerable. The vehicle body 12 defines, in part, a passenger compartment 20 having seats 23 positioned behind a dashboard 26. The vehicle body 12 further defines, in part, a prime mover compartment 14 that houses a prime mover. The prime mover may be, for example, an engine, a motor, or both an engine and a motor in a hybrid configuration. The vehicle body 12 further includes front doors 18 and front side windows 13 disposed above the front doors 18, and rear doors 19 and rear side windows 15 disposed above the rear doors 19.

The vehicle body 12 may further include a rear door frame assembly 100. The vehicle body 12 may include the rear door frame assembly 100 on each side of the vehicle 10 such that the vehicle body 12 includes two rear door frame assemblies 100. For simplicity, a rear door frame assembly 100 on a left side of the vehicle 10 is shown and described herein. However, a person of ordinary skill in the art would appreciate that the rear door frame assembly 100 on a right side of the vehicle 10 would have a similar configuration. The rear door frame assembly 100 includes a rear door frame 101 surrounding and partially overlapping the rear door 19 and the rear side window 15, a quarter window 105 disposed to a rear of the rear side window 15, and a division post 103 disposed between the rear side window 15 and the quarter window 105. In FIG. 1, the division post 103 is hidden behind the rear door 19.

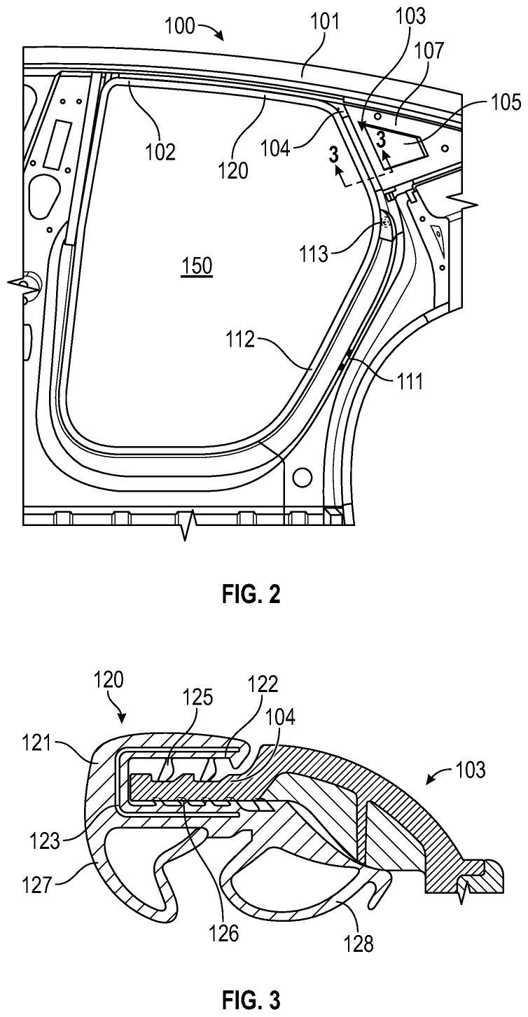

FIG. 2 shows a rear door fame assembly 100 with the rear door 19 and rear side window 15 removed according to a non-limiting example. The rear door frame assembly 100 may further include a quarter window backer 107 disposed to the rear of the division post 103. The quarter window backer 107 may be a separate structure from the division post 103, or the quarter window backer 107 and the division post 103 may be formed as a unitary structure. In cases where a vehicle includes a front quarter window, the division post 103 may be incorporated into an A-pillar. The quarter window 105 may be supported by the quarter window backer 107. The rear door frame assembly 100 further includes a quarter panel 111. The rear door frame 101, the division post 103, and the quarter panel 111 together define a rear door opening 150. The division post 103 may be, for example, plastic or metal.

The rear door frame 101 includes a rear door frame flange 102, the division post 103 includes a division post flange 104, and the quarter panel 111 includes a quarter panel flange 112. The rear door frame flange 102, the division post flange 104, and the quarter panel flange 112 may together continuously surround the rear door opening 150. A rear door seal 120 is disposed on the rear door frame flange 102, the division post flange 104, and the quarter panel flange 112 around the rear door opening 150. The rear door seal 120 may be formed as one continuous piece around the rear door opening 150. Alternatively, the rear door seal 120 may be formed as segments that together form a continuous seal around the rear door opening 150. A joint structure 113 may be formed where the division post 103 is joined to the quarter panel 111.

FIG. 3 shows a cross-sectional view of a rear door seal 120 disposed on a division post 103 according to a non-limiting example. The rear door seal 120 includes a main seal body 121 that is, for example, C-shaped and having a stiffening structure 123 that may, for example, be U-shaped, enclosed therein. The main seal body 121 further includes a seal carrier 122 having a first set of teeth 125 and a second set of teeth 126 extending therefrom. The first set of teeth 125 and the second set of teeth 126 may be elastic are disposed so as to oppose each other. The seal carrier 122 is clamped around the division post flange 104 extending from the division post 103 via the first set of teeth 125 and the second set of teeth 126. That is, the division post flange 104 is inserted in a gap between the first set of teeth 125 and the second set of teeth 126 to secure the rear door seal 120 on the division post 103. The gap between the first set of teeth 125 and the second set of teeth 126 may be set to be less than a thickness of the division post flange 104 such that the first set of teeth 125 and the second set of teeth 126 deform against the division post flange 104 and the first set of teeth 125 and the second set of teeth 126 press against the division post flange 104 to secure the rear door seal 120 on the division post 103. Additionally, due to the deformation, the first set of teeth 125 and the second set of teeth 126 may form a seal around the division post flange 104. The stiffening structure 123 may help maintain the stiffness of the main seal body 121 as the first set of teeth 125 and the second set of teeth 126 are pressed outward by the division post flange 104.

A first elastic sealing structure 127 and a second elastic sealing structure 128 are disposed on the main seal body 121 spaced from each other. The first elastic sealing structure 127 and the second elastic sealing structure 128 may be formed as hollow structures. The first elastic sealing structure 127 and the second elastic sealing structure 128 may be structured such that, when the rear door 19 is closed and presses against terminal ends thereof, the first elastic sealing structure 127 and the second elastic sealing structure 128 deform to create a watertight seal against the rear door 19. The first elastic sealing structure 127 may be formed with an indentation facing the second elastic sealing structure 128, and the second elastic sealing structure 128 may be formed with a projection facing the first elastic sealing structure 127, such that as the first elastic sealing structure 127 and the second elastic sealing structure 128 deform due to closing of the rear door 19, the projection of the second elastic sealing structure 128 folds into the indentation of the first elastic sealing structure 127 to form a seal therebetween.

While only the cross-sectional view of the rear door seal 120 disposed on the division post 103 is shown, the rear door seal 120 may be secured to the rear door frame 101 by clamping onto the rear door frame flange 102 of the division post 103 and the quarter panel flange 112 of the quarter panel 111 in a similar manner as discussed above for the division post 103.

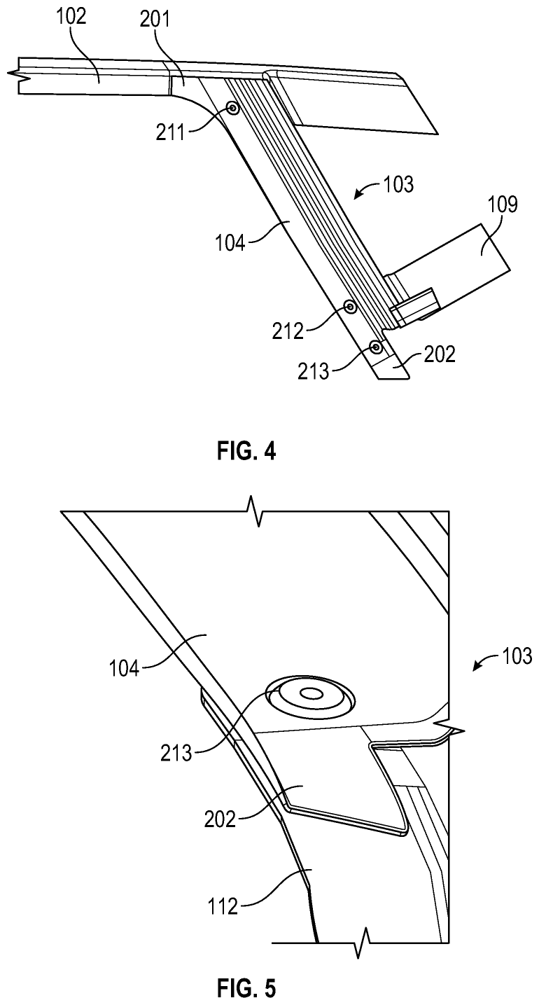

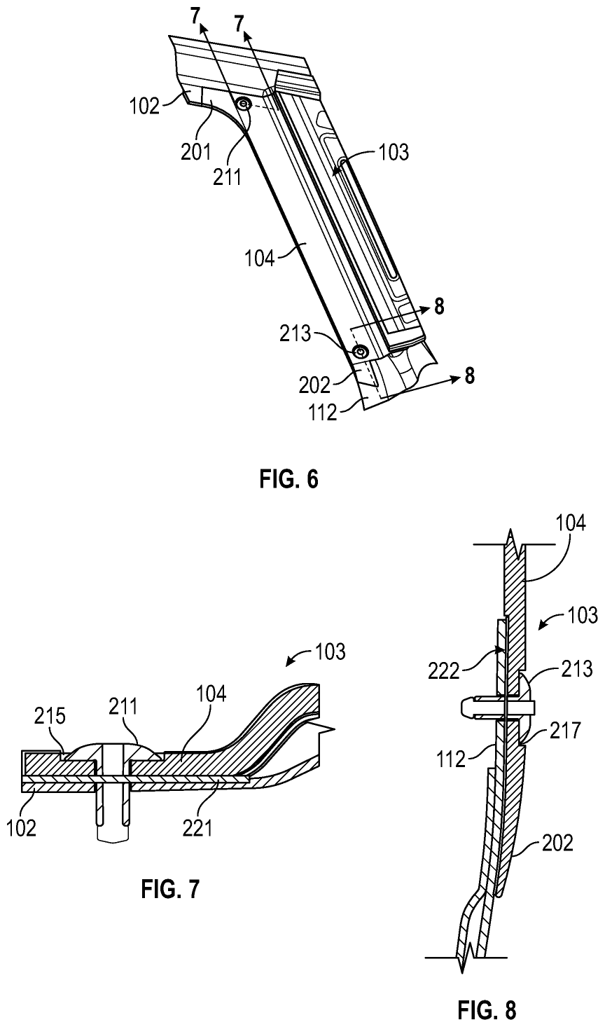

FIGS. 4-6 show a division post flange 104 of a division post 103 attached to a rear door frame flange 102 of a rear door frame 101 and a quarter panel flange 112 of a quarter panel 111 according to a non-limiting example. The division post flange 104 may be attached to the rear door frame flange 102 via a first fastener 211 through apertures formed in the division post flange 104 and the rear door frame flange 102. The division post flange 104 may be attached to the quarter panel flange 112 of the quarter panel 111 via a second fastener 213 through apertures formed in the division post flange 104 and the quarter panel flange 112. As shown in FIG. 4, a third fastener 212 may also form a secondary attachment point between the division post flange 104 and the quarter panel flange 112 through additional apertures formed in the division post flange 104 and the quarter panel flange 112. Alternatively, the division post 103 may be formed integrally with the quarter window backer 107. Furthermore, the second fastener 213 may be sufficient to attach the division post flange 104 and the quarter panel flange 112 such that the third fastener 212 may be omitted, as shown in FIG. 6. The first, second, and/or third fasteners 211, 213, 212 may be, for example, rivets, bolt-and-nut structures, or other fasteners known in the art. The first, second, and/or third fasteners 211, 213, 212 may be used as primary datums for assembly.

A first tapered portion 201 may be formed at a top end of the division post flange 104. The first tapered portion 201 may extend in the forward direction from the division post flange 104. One side of the first tapered portion 201 is mounted flush atop the rear door frame flange 102, and the other side of the first tapered portion 201 is tapered to decrease in thickness as it extends away from the division post flange 104.

A second tapered portion 202 may be formed at a bottom end of the division post flange 104. The second tapered portion 202 may extend in the downward direction from the division post flange 104. One side of the second tapered portion 202 is mounted flush atop the quarter panel flange 112, and the other side of the second tapered portion 202 is tapered to decrease in thickness as it extends away from the division post flange 104.

FIG. 7 shows a cross-section taken at 7-7 in FIG. 6 of a division post flange 104 attached to a rear door frame flange 102 according to a non-limiting example. A top portion of the first fastener 211 may be disposed in an indentation 215 formed in the division post flange 104 of the division post 103. A first sealing patch 221 is sandwiched between the division post flange 104 and the rear door frame flange 102. The first sealing patch 221 may be formed of a compressible material, for example, foam or urethane. As the first fastener 211 fastens the division post flange 104 and the rear door frame flange 102 together, the first sealing patch 221 is compressed therebetween to form a watertight seal. The division post flange 104 may have a reduced thickness where an overlap occurs with the rear door frame flange 102.

FIG. 8 shows a cross-section taken at 8-8 in FIG. 6 of a division post flange 104 attached to a quarter panel flange 112 according to a non-limiting example. A top portion of the second fastener 213 may be disposed in an indentation 217 formed in the division post flange 104 of the division post 103. A second sealing patch 222 is sandwiched between the division post flange 104 and the quarter panel flange 112. The second sealing patch 222 may be formed of a compressible material, for example, foam or urethane. As the second fastener 213 fastens the division post flange 104 and the quarter panel flange 112 together, the second sealing patch 222 is compressed therebetween to form a watertight seal. The second sealing patch 222 may extend to the second tapered portion 202. Alternatively, the second sealing patch 222 may terminate above the second tapered portion 202. The division post flange 104 may have a reduced thickness where an overlap occurs with the quarter panel flange 112.

While first and second sealing patches 221, 222 are described above, the first and second sealing patches 221, 222 may be formed as a single patch that seals the ends of the division post 103 and around the entire window perimeter. As non-limiting examples, the first and second sealing patches 221, 222 may be formed using a pumpable adhesive/sealant or a compressible foam gasket that is glued to the plastic carrier.

As a non-limiting example, the division post 103 may be formed of plastic. The division post 103 may be formed of molded plastic or 3D printed plastic.

Referring again to FIG. 2, the rear door frame flange 102, the division post flange 104, and the quarter panel flange 112 together form a continuous perimeter around the rear door opening 150. When the rear door seal 120 is disposed around the rear door frame flange 102, the division post flange 104, and the quarter panel flange 112, uneven structures such as notches, steps voids, changes in attachment strategy, and broken sealing planes may create an interruption in sealing between rear door seal 120 and the rear door frame flange 102, the division post flange 104, and the quarter panel flange 112. Specifically, such uneven structures may reduce efficacy of the seal as the seal carrier 122 is clamped onto the rear door frame flange 102, the division post flange 104, and the quarter panel flange 112. Such uneven structures may occur at transitions between the rear door frame flange 102, the division post flange 104, and the quarter panel flange 112. As explained above, a first tapered portion 201 may extend from the division post flange 104 at a transition between the division post flange 104 and the rear door frame flange 102, and a second tapered portion 202 may extend from the division post flange 104 at a transition between the division post flange 104 and the quarter panel flange 112. The division post flange 104 may overlap the rear door frame flange 102 and the quarter panel flange 112, and the first and second tapered portions 201, 202 may mimic the surfaces of the rear door frame flange 102 and the quarter panel flange 112 to which the division post flange 104 is mounted.

The first and second tapered portions 201, 202 allow the seal carrier 122 to transition gradually between the rear door frame flange 102, the division post flange 104, and the quarter panel flange 112 with little to no uneven structures reducing efficacy of the seal. The seal carrier 122 may be uninterruptedly disposed on the rear door frame flange 102, the division post flange 104, and the quarter panel flange 112 around the rear door opening 150. Additionally, the arrangement of the rear door frame 101, the division post 103, and the quarter panel 111 as disclosed herein may improve load carry capability of the rear door frame flange 102, the division post flange 104, and the quarter panel flange 112.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A sealing assembly, comprising:
a first structure having a first flange;
a second structure having a second flange that partially overlaps the first flange;
a fastener that attaches the first flange to the second flange at a region where the first flange and the second flange overlap; and
a seal disposed over the first flange and the second flange.

2. The sealing assembly of claim 1, wherein the first structure comprises a tapered portion at the region where the first flange and the second flange overlap and the seal is disposed over the tapered portion.

3. The sealing assembly of claim 1, further comprising:
a sealing patch disposed between the first flange and the second flange at the region where the first flange and the second flange overlap,
wherein the fastener brings the first flange and the second flange together to compress the sealing patch.

4. The sealing assembly of claim 1, wherein the seal is disposed over the fastener.

5. A vehicle sealing assembly, comprising:
a division post having a division post flange;
a door frame having a door frame flange;
a first fastener that attaches the division post flange to the door frame flange at a region where the division post flange and the door frame flange overlap; and
a seal disposed over the division post flange and the door frame flange.

6. The vehicle sealing assembly of claim 5, wherein the division post comprises a first tapered portion at the region where the division post flange and the door frame flange overlap and the seal is disposed over the first tapered portion.

7. The vehicle sealing assembly of claim 5, further comprising:
a first sealing patch disposed between the division post flange and the door frame flange at the region where the division post flange and the door frame flange overlap,
wherein the first fastener brings the division post flange and the door frame flange together to compress the first sealing patch.

8. The vehicle sealing assembly of claim 5, wherein the seal is disposed over the first fastener.

9. The vehicle sealing assembly of claim 5, further comprising:
a quarter panel having a quarter panel flange; and
a second fastener that attaches the division post flange to the quarter panel flange at a region where the division post flange and the quarter panel flange overlap;
wherein the seal is disposed over the quarter panel flange.

10. The vehicle sealing assembly of claim 9, wherein the division post comprises a second tapered portion at the region where the division post flange and the quarter panel flange overlap and the seal is disposed over the second tapered portion.

11. The vehicle sealing assembly of claim 9, further comprising:
a second sealing patch disposed between the division post flange and the quarter panel flange at the region where the division post flange and the door frame flange overlap,
wherein the second fastener brings the division post flange and the quarter panel flange together to compress the second sealing patch.

12. The vehicle sealing assembly of claim 9, wherein the seal is disposed over the second fastener.

13. The vehicle sealing assembly of claim 9, wherein the door frame flange, the division post flange, and the quarter panel flange together form a continuous perimeter of an opening.

14. The vehicle sealing assembly of claim 13, wherein the seal is disposed continuously on the continuous perimeter of the opening.

15. The vehicle sealing assembly of claim 6, wherein the first tapered portion extends from the division post in a forward direction of a vehicle on which the vehicle sealing assembly is configured to be disposed.

16. The vehicle sealing assembly of claim 10, wherein the second tapered portion extends from the division post in a downward direction of a vehicle on which the vehicle sealing assembly is configured to be disposed.

17. The vehicle sealing assembly of claim 5, wherein the division post is formed as a unitary structure with a quarter window backer.

18. A vehicle comprising:
a vehicle body;
a rear door frame having a rear door frame flange;
a quarter panel having a quarter panel flange;
a division post extending between the rear door frame and the quarter panel and having a division post flange;
a rear door assembly including a rear door and a rear window disposed over at least a portion of each of the rear door frame, the quarter panel, and the division post;
a first fastener that attaches the division post flange to the rear door frame flange at a region where the division post flange and the rear door frame flange overlap;
a second fastener that attaches the division post flange to the quarter panel flange at a region where the division post flange and the quarter panel flange overlap; and
a seal disposed over the division post flange, the rear door frame flange, and the quarter panel flange.

19. The vehicle of claim 18,
wherein the division post comprises a first tapered portion at the region where the division post flange and the rear door frame flange overlap,
wherein the division post comprises a second tapered portion at the region where the division post flange and the quarter panel flange overlap, and
wherein the seal is disposed over the first tapered portion and the second tapered portion.

20. The vehicle of claim 18, further comprising:
a first sealing patch disposed between the division post flange and the rear door frame flange at the region where the division post flange and the rear door frame flange overlap, and
a second sealing patch disposed between the division post flange and the quarter panel flange at the region where the division post flange and the rear door frame flange overlap,
wherein the first fastener brings the division post flange and the rear door frame flange together to compress the first sealing patch, and
wherein the second fastener brings the division post flange and the quarter panel flange tougher to compress the second sealing patch.
